(19) United States
(12) Patent Application Publication
(10) Pub. No.: US 2006/0016354 A1
(43) Pub. Date: Jan. 26, 2006

(54) Method and device for adjusting the colour density on material to be printed

(75) Inventor: Lutz Telljohann, Lengerich (DE)

Correspondence Address: JACOBSON HOLMAN PLLC, 400 SEVENTH STREET N.W., SUITE 600, WASHINGTON, DC, 20004, US

(73) Assignee: WINDMOELLER 7 HOELSCHER KG

(21) Appl. No.: 10/528,579

(22) PCT Filed: Sep. 15, 2003
(86) PCT No.: PCT/EP03/10264

§ 371 Date: Mar. 21, 2005

(30) Foreign Application Priority Data
Oct. 2, 2002 (DE) 102-46-271.2

(51) Int. Cl. B41F 1/46

(52) U.S. Cl. 101/348

(57) ABSTRACT

The invention relates to a rotary printing press comprising at least one inking roller (3, 4), which transports printing ink, composed essentially of pigments and solvent, from an ink reservoir (2, 12) towards the material to be printed (5). The intensity of colour on the material to be printed (5) is adjusted by means of the mixing ratio of pigments to solvent in the colour that is transferred to the material to be printed (5). The mixing ratio of pigments to solvent in the ink can be influenced by a device that aids the evaporation of the solvent, said device acting on one of the inking rollers (3, 4).

The invention has to do with a mechanism for setting the density of ink dots on a print substrate according to the first portion of Claim 1.

Rotary printing machines possess at least one ink transfer roller which conveys towards a print substrate ink from an ink reservoir, which as a rule is an ink pan or a coater chamber supplied with ink from an ink tank. With flexoprinting machines of the more recent type of construction both the anilox roller, which conveys ink from the ink chamber coater to the press plate, as well as the press plate itself that takes up ink from the anilox roller and further conveys it to the print substrate, are ink transfer rollers as defined in the invention at hand. With rotogravure only the gravure cylinder is to be characterized as an ink transfer roller.

The formulation “towards” in the first portion of Claim 1 is to be understood in reference to the transfer direction of the ink by means of the respective rollers.

With the printing process on rotary printing machines it is often desired to alter the intensity of the hue to be applied to the print substrate. The intensity effect is caused by means of the density of the ink.

Various options exist to influence the intensity of a hue on the print substrate. The ink density on the print substrate on the one hand is influenced by the quantity of printing ink applied. The quantity of the ink applied is thereby often influenced in that the color separation is varied between the individual rollers involved in the printing process. For this purpose the viscosity of the printing ink is influenced. With the varying quantity of ink transferred by means of the rollers, however, the layer densities applied to the print substrate can be different.

As an alternative thereto the ink density on the print substrate can also be set by means of the ratio of color pigments to solution in the printing ink. With such a familiar type of method the ink density first is measured with an appropriate measuring device, somewhat like a densitomer, in order to set the ink density on the print substrate. In order now to be able to vary the ink density, the ratio of ink particles to solutions in the ink supply tank must be modified. The ratio of ink particles to solutions in the ink supply tank is modified by refilling concentrated printing ink and/or solution. This is very laborious because this process often becomes necessary several times, often leads to inconclusive results and all the old ink must be uniformly thoroughly mixed in with the ink components added later in order to obtain a stable print image. For this reason the printing process often even has to be interrupted.

For this reason the task for the invention at hand consists in proposing a method and a mechanism that provide the option of being able to influence the ink density on the print substrate without refilling printing ink and/or solution into the ink tank.

The problem is resolved by means of the distinguishing characteristics of Claim 1.

Preferably bellows are planned for supporting the evaporation of the solution. They blow a suitable gas, for example air, onto one of the ink transfer rollers so there is an exchange of ambient air enriched with solutions.

Particularly advantageous is the arrangement of suckers for supporting evaporation of the solution. With aid of such a sucker the volume stream of an appropriate gas, for example air, led by the ink transfer roller is increased so that even here there is an exchange of enriched ambient air with solutions.

Of course besides the bellows other functional units supporting evaporation can be assigned to the ink transfer roller as well. These can be infrared, microwave or other radiation emitting devices that irradiate the ink on the ink transfer roller. Moreover, mechanisms for separating laminar border layers adhering to moved parts can be utilized. It is known that these laminar border layers have a stark adverse effect on air exchange and thereby evaporation. The separating of a laminar border layer is necessitated by means of mechanical components, for example the turbulence generators depicted in DE 100 34 708 A1, but also by means of electrical and/or magnetic fields (cf. DE 195 25 453 A1 and DE 100 50 301 A1). Finally, mechanisms for heating up of the ink transfer rollers can also be designed.

It is particularly advantageous to arrange between the blower and the next ink transfer roller a second ink reservoir, which provides the option of applying additional ink to the ink transfer roller. Thus the volume loss arising by means of evaporation of solution can be offset so that even with various evaporation rates of the solution the same volumes of printing ink are still transferred to the next ink transfer rollers.

In order to have a most varied possible ability to influence the ink transfer roller, in an additional preferred embodiment at least one additional mechanism for supporting evaporation is planned that has an effect on another part of the scope of an ink transfer roller.

In a particularly preferred arrangement, in the direction of ink transfer in the printing machine a mechanism for supporting evaporation of solution on an ink transfer roller in each case follows each ink reservoir through which the ink is applicable to an ink transfer roller.

In order to be able purposefully to influence the quantity of color pigments that are finally applied to the printing substrate, the output of the mechanisms for supporting evaporation of the solutions is controllable and/or adjustable.

A rotary printing machine according to the invention:

With the invention-related method for setting the ink intensity on a print substrate, the mixing ratio of color pigments and solution in the printing ink is set by purposefully influencing the evaporation of solutions on one of the ink transfer rollers. In this way the density of the ink on the print substrate can be controlled without having to interrupt the printing process.

The individual figures show:

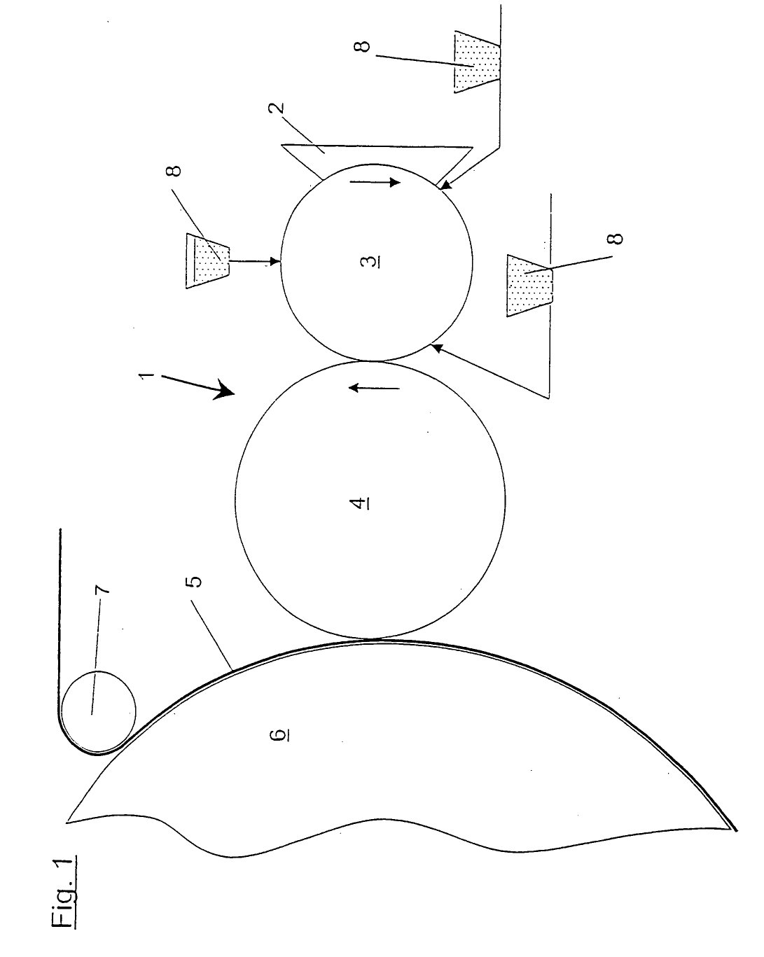

FIG. 1 A sketch of the familiar method and of the related mechanism for applying printing ink to the print substrate

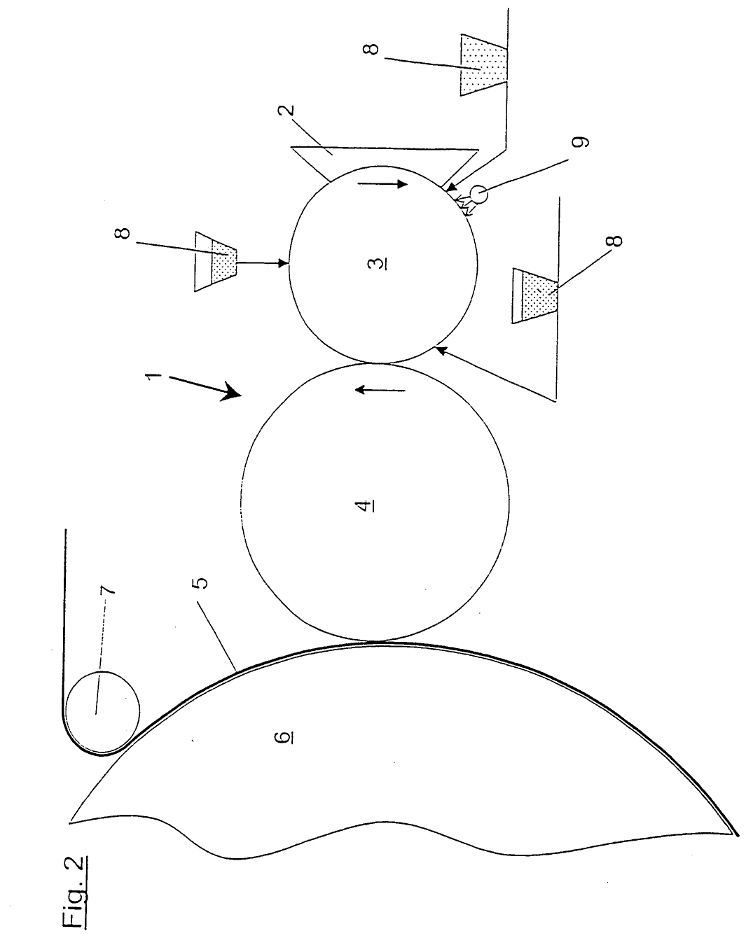

FIG. 2 A sketch of the invention-related method and the related Mechanism for lowering the ink density

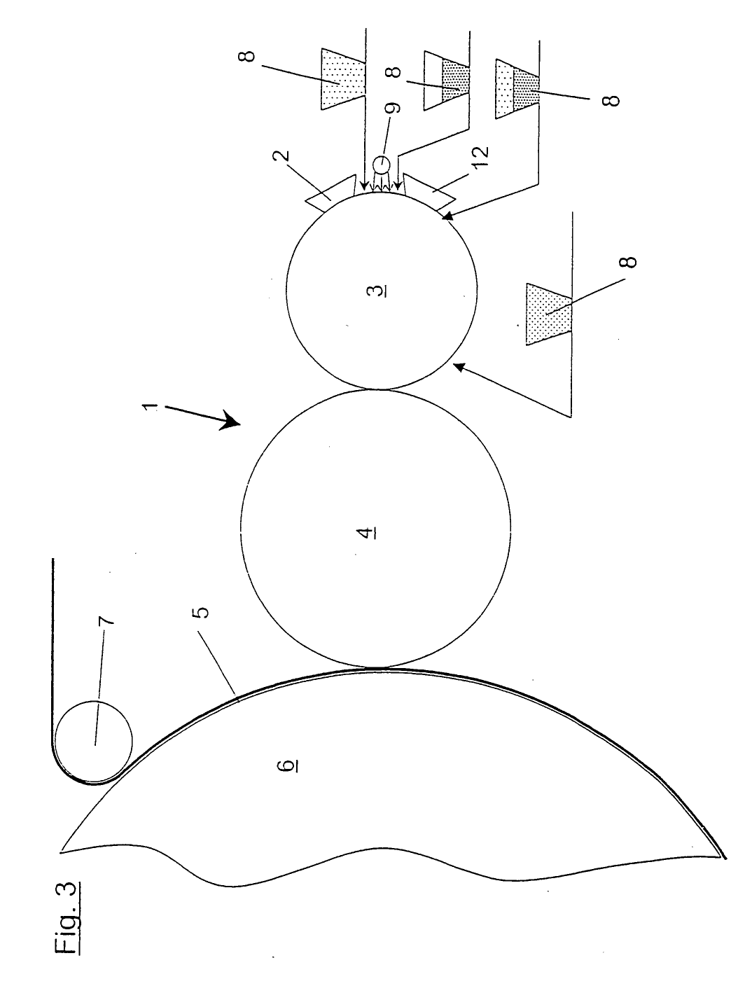

FIG. 3 Sketch of a mechanism for implementing the method for raising the ink density

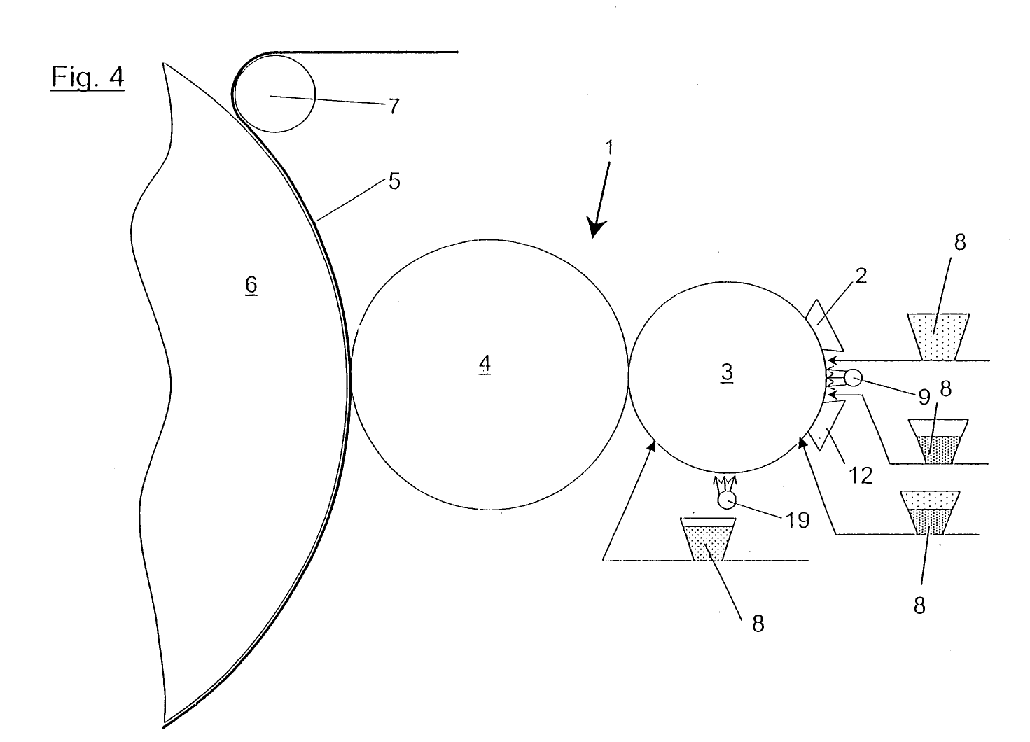

FIG. 4 Sketch of a mechanism for implementing the method for raising or lowering ink density

FIG. 1 shows a sketch of the implementation of the generally common method for application of printing ink to a print substrate with the aid of a familiar rotary printing machine=s inking unit 1. The printing ink is introduced from an ink tank not depicted via lines and pumps also not shown through ink chamber coating 2 in a way that the ink chamber coating 2 always contains a certain volume of printing ink. The ink chamber coating 2 is thereby to be regarded as an ink reservoir. Now if the ink chamber coating 2 traverses an ink fountain 8 of the anilox roller 3 then this fountain 8 is subsequently filled to the brim with printing ink and thus reaches the printing roller 4. The printing roller 4 now takes up a part of the printing ink. A certain remainder of the printing ink remains, though, in the fountain 8. This type of breaking up of the printing ink is generally characterized as color separation. Upon another traversing of the ink stored in the ink chamber coater 2 the reservoir is again filled up to the upper brim so that the ink transfer process can start once more.

The printing roller 4 conveys printing ink onto the print substrate 5 in an inherently familiar way, whereby the print substrate 5 that is introduced by a guide roller 7 rests on a counter-pressure cylinder 6.

The FIG. 2 shows a mechanism that serves to lower the ink density on the print substrate 5 when necessary. An air hose 9 is attached to the anilox roller 3 in this case in the transfer direction behind the ink chamber coater 2. Now if the ink chamber coater 2 traverses the considered fountain 8, then the latter is completely filled with printing ink. Subsequently, the filled fountain 8 is blown onto with the aid of the Controllable air nozzle 9. Thus the evaporation of solution contained in the printing ink is increased leading to more color pigments being transferred on the print substrate during an ink application of equal volume. This condition, as already mentioned many times, would lead to a more intensive color impression on the print substrate. With the embodiment pursuant to FIG. 2, however, the printing ink fill level has been lower in the ink fountain 8.

The delivery of ink to the printing roller 4 is made difficult by this condition, since a poorer contact occurs between printing ink and printing roller 4 if the ink fountain 8 in the coater roller 3 is not filled to its upper rim. The color separation is thus modified. For this reason, with the embodiment pursuant to FIG. 2, less ink is transferred than with the mechanism shown in FIG. 1, where the mixing ration is not influenced in the invention-related way. At any rate, with this embodiment it can also come down to a rise in the ink intensity depending on the type and transfer ratio of the printing ink. This is particularly the case if with a relatively slight rise in the ink evaporation on the rollers 3, 4 involved in ink transfer, the ink fountains 8 are still filled to the extent that the ink transfer is hardly adversely affected while the concentration of the color pigments in the ink already increases noticeably. In both cases, however, noticeable modifications in the print image can be brought about without the ink composition in the ink tank having to be changed.

FIG. 3 shows a mechanism that can be used in any operating condition for a distinct heightening in the intensity of the color on the print substrate 5. Increasing a portion of the color pigments in the printing ink achieves this result. Here two ink chamber coaters 2, 12 are planned that are arranged on the anilox roller 3. An air nozzle 9 is arranged between these two ink chamber coaters 2, 12. The considered fountain 8 first traverses the ink chamber coater 2 and is completely filled with printing ink. Subsequently blown air from the air nozzle 9 arrives on the ink fountain 8 so that even here again solution is quickly evaporated and in the remaining printing ink the portion of color pigments is increased. Simultaneously a film builds up on the surface of the remaining printing ink. When traversing the second ink chamber coater 12 the ink fountain 8 is filled again to the upper rim. At the same time the film prevents the printing ink already located in the ink reservoir 8 from being exchanged. The increased portion of color pigments thus remains intact, even after adding fresh printing ink.

On the way between the second ink chamber coater 12 and the print substrate 5 fresh ink is now able to etch the film. Both parts of the printing ink can commix. The printing ink now contained in the ink fountain 8 has a slightly elevated color pigment portion in relation to the original printing ink. On the print substrate 5, an increased ink density can be subsequently observed that leads to a heightened intensity in the corresponding color.

With the mechanism shown in FIG. 4, the color pigment portion in the printing ink can be raised or lowered as need be. For this reason, the mechanism shown in FIG. 3 has been expanded by an additional controllable air nozzle 19 that is arranged in the transfer direction behind the second ink chamber coater 12. First, the considered ink fountain 8 in the ink chamber coater 2 completely filled with printing ink. After traversing the bellows stream from the air nozzle 9, less solution is located in the printing ink and a film has built up. While traversing the second ink chamber coater 12 the missing ink in the ink reservoir 8 is introduced. The second air nozzle 9 is arranged in such a way that it then blows onto the ink fountain 8 if the printing ink in the ink reservoir has sufficiently commixed. The use of the second air nozzle 19 leads to the additional evaporation of solution so that on the one hand the fill volume of the ink reservoir 8 is decreased but simultaneously the ink particle portion is raised. Using the appropriate settings on both the air nozzles 9, 19, this method allows for the ink density on the print substrate 5 to be finely adjusted with regard to the ink density preset by the printing ink and other parameters of influence so that various color intensities are represented without the printing process having to be interrupted.

List of Reference Codes

| | |
|---|---|
| 1 | Inking unit |
| 2 | Ink chamber coaler |
| 3 | Ink transfer roller |
| 4 | Printing roller |
| 5 | Print substrate |
| 6 | Counter-pressure cylinder |
| 7 | Guide roller |
| 8 | Ink fountain |
| 9 | Air nozzle |
| 10 | |
| 11 | |
| 12 | Ink chamber coater |
| 13 | |
| 14 | |
| 15 | |
| 16 | |
| 17 | |
| 18 | |
| 19 | Air nozzle |
| 20 | |
| 21 | |
| 22 | |
| 23 | |
| 24 | |
| 25 | |
| 26 | |
| 27 | |
| 28 | |

1. Rotary printing machine with at least one ink transfer roller (3, 4),
which transfers ink that particularly consists of color pigments and solutions towards a print substrate (5) ink from an ink reservoir (2),
whereby the intensity of the ink on the print substrate (5) is adjustable through the mixture ratio of the color pigments and the solution in the ink that is transferred from the machine to the print substrate (5)
characterized in that
the mixture ratio of the color pigments and the solution in the ink, which is transferred by the machine onto the print substrate (5) by means of at least one mechanism for supporting evaporation of solution (9, 19) on at least one ink transfer roller (3, 4), is influenceable.

2. Rotary printing machine according to claim 1,
characterized in that
it includes at least one mechanism for supporting evaporation of solution (9, 19) on the ink transfer roller (3, 4) that has a blower which blows a suitable gas such as air onto the ink transfer roller (3, 4).

3. Rotary printing machine according to claim 1
Characterized in that
it includes at least the one mechanism for supporting evaporation of solution (9, 19) on the ink transfer roller (3, 4) and has a sucker which increases the volume flow of a suitable gas, such as air, that is led by the ink transfer roller.

4. Rotary printing machine according to claim 1
Characterized in that
it includes at least one mechanism for supporting the evaporation of solution (9, 19) on the ink transfer roller (3, 4) with the following functional units:
radiant sources, as in particular infrared radiators or microwave emitting devices which spray the ink on at least one ink transfer roller,
mechanisms for separating of the laminar border layer adhering to the ink transfer roller,
mechanisms for heating up of at least one of the ink transfer roller.

5. Rotary printing machine according to claim 1
Characterized in that
at least a second ink reservoir (12), which is arranged in the transfer direction between the ink transfer roller (3, 4) and the mechanism for supporting evaporation of solutions (9, 19) on an ink transfer roller (3, 4)
and through which additional ink can be applied to the in transfer roller (3, 4)

6. Rotary printing machine according to claim 1
Characterized in that
at least one other mechanism for supporting of evaporation of solution (9, 19) has an effect on at least one ink transfer roller (3, 4),
which influences another part of the scope of the ink transfer roller (3, 4).

7. Rotary printing machine according to claim 4
Characterized in that
in each case in the ink transfer direction in the printing machine one mechanism for supporting evaporation of solutions (9, 19) on at least one ink transfer roller (3, 4) follows ink that is applicable onto an ink reservoir (2, 12) through which ink can be applied onto an ink transfer roller (3, 4),

8. Rotary printing machine according to claim 1
Characterized in that
the output of mechanisms for supporting the evaporation of solution (9, 19) on at least one ink transfer roller (3, 4) in operating the printing machine can be controlled and/or regulated.

9. Method for setting the ink intensity on a print substrate (5) printed by a rotary printing machine
whereby the rotary printing machine is equipped with at least one ink transfer roller (3, 4),
which transfers ink toward a print substrate, that in particular consists of color pigments and solutions, from a ink reservoir (2, 12) in the direction of a print substrate (5),
and whereby the intensity of the ink on the print substrate (5) is set through the mixing ratio of the color pigments and the solution in the ink which is transferred by the machine
characterized in that
the mixing ratio of the color pigment and the solutionis set by the evaporation of solution being supported on at least one ink transfer roller (3, 4).
